(19) United States
(12) Patent Application Publication
(10) Pub. No.: US 2021/0295312 A1
(43) Pub. Date: Sep. 23, 2021

(54) MOBILE WALLETS FOR PROGRAMMING AND MANAGING SMART CARDS

(71) Applicant: Wells Fargo Bank, N.A., San Francisco, CA (US)

(72) Inventor: Joon Maeng, Newcastle, WA (US)

(21) Appl. No.: 14/989,305

(22) Filed: Jan. 6, 2016

Related U.S. Application Data
(60) Provisional application No. 62/273,066, filed on Dec. 30, 2015.

(51) Int. Cl. G06Q 20/36; G07F 7/08; G06K 19/07; G06Q 20/34

(52) U.S. Cl. CPC G06Q 20/3672; G06Q 20/3433; G06K 19/0723; G07F 7/0806

(57) ABSTRACT

Methods and systems for programming a smart card having a programmable chip with no value using a mobile wallet associated with a mobile device are disclosed. The methods and systems can receive issuer data identifying an issuer for the smart card and receive an amount to load on the card. A selection of a wallet element from the mobile wallet as a payment source for the amount can be received and a transaction request can be submitted for the issuer using the selected wallet element and the amount. After submitting the transaction request and receiving an issuer authorization, data regarding the amount can be written on the programmable chip of the smart card.

### TECHNICAL FIELD

Embodiments described herein generally relate to mobile wallets and, for example and without limitation, programming and managing smart cards using mobile wallets.

### BACKGROUND

Mobile wallets can allow consumers to make contactless payments for products and services with mobile devices such as phones or watches instead of cash, credit cards or checks. Using an antenna in the mobile device, mobile wallets can communicate with contactless readers using near field communication (NFC). They can allow consumers to make secure payments in a relatively quick manner by placing their mobile devices near contactless readers at stores. Mobile wallets can also be used to make purchases within applications on mobile devices and over the internet.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which;

FIG. 1. illustrates a schematic diagram of a system, according to various examples;

FIG. 2 illustrates an environment for programming a smart card, according to various examples;

FIG. 3 illustrates a smart card data structure, according to various examples;

FIG. 4 illustrates a process of using and managing a smart card, according to various examples;

FIG. 5 illustrates an environment for programming a smart card, according to various examples;

FIG. 6 illustrates a process of programming, using and managing a smart card, according to various examples;

FIG. 7 illustrates method for programming a smart using a mobile wallet, according to various examples;

FIG. 8 is a block diagram of a machine in the example form of a computer system within which a set of instructions, for causing the machine to perform any one or more of the methodologies discussed herein, may be executed.

### DETAILED DESCRIPTION

The present disclosure describes systems and methods for programming and managing a smart card using a mobile wallet. In one example, the smart card can be a merchant-specific smart card issued by a merchant (e.g., Walmart®) and having no value associated with the card. The card can be obtained from the merchant and programmed using a mobile wallet of a user (or giver) who can give the smart card to a recipient as a gift for example. Programming the smart card can include for example associating the smart card with a payment element on the giver's mobile wallet. During programming, the issuer of the payment element (e.g., Visa®) can be informed of the smart card, its personal identifier(s) and usage restrictions programmed by the giver. In this example, the smart card can be used at the specific merchant (or others authorized by the merchant) to purchase items. In another example, the smart card can be a credit or debit card issuer-specific smart card issued by a card issuer (e.g., a Visa®) and having no value associated with the card. The smart card can be programmed using a mobile wallet of a user (or giver) including associating the smart card with a payment element on the giver's mobile wallet issued by the card issuer (e.g., a Visa® credit card element). In this way, the smart card can be programmed to be a personal credit card associated with the giver's payment element and/or the credit card account associated with the payment element, for example. The smart card can be obtained from the card issuer or elsewhere such as a retail location and can be used as a credit or debit card at any merchant, for example. In one application, the smart card can be a temporary credit card (e.g., having a time restriction) provided by an employer to an employee for travel. These are some examples of programming and managing smart cards using a mobile wallets. Further examples are discussed herein.

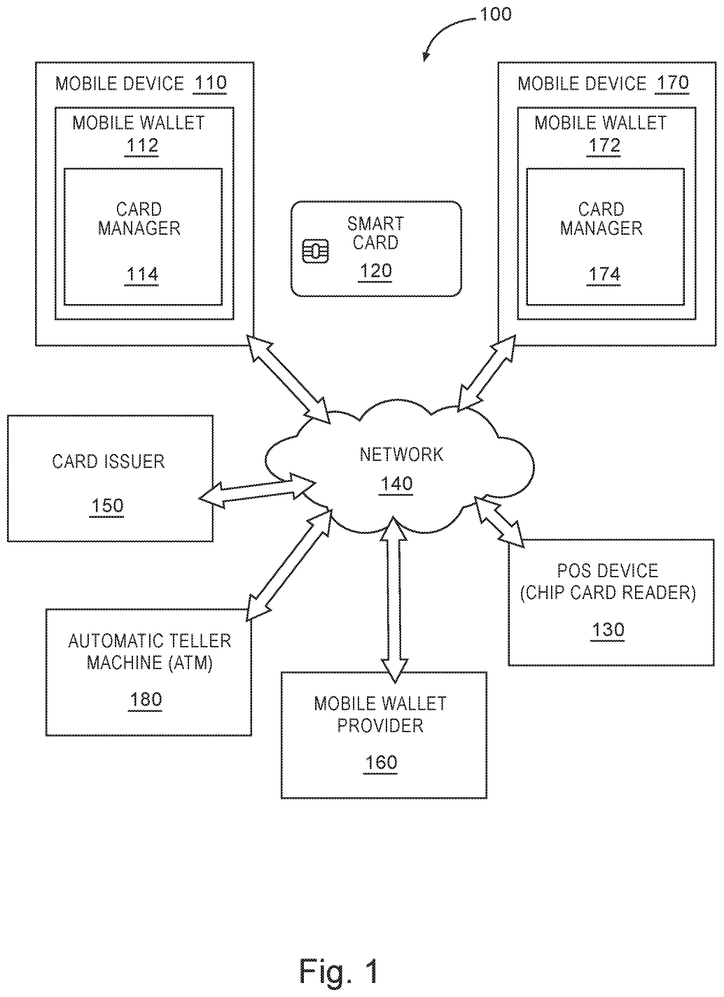

FIG. 1 illustrates an environment 100 for programming a smart card with a mobile wallet, according to an example. The environment 100 includes a mobile devices 110, 170 having mobile wallets 112, 172, a programmable smart card 120, a point-of-sale (POS) device 130, a card issuer 150, a mobile wallet provider 160, an automatic teller machine (ATM) 180, and a network 140. The mobile wallet 112, 172 can include card manager applications 114, 174 respectively for programming and using smart cards. A mobile wallet can be an application (sometimes, simply referred to as a mobile wallet) such as a digital or electronic wallet application operating on a personal computing device such as a personal computer, laptop computer, smart phone, smart watch or tablet or can be an application operating on an external system (e.g., wallet service provider 160) accessible by a personal computing device over a network. Example mobile wallet applications include those provided by Apple Pay, Google Wallet, Samsung Pay, and Starbucks Mobile App.

A mobile wallet can include a number of different wallet elements or items including credit cards, debit cards, reward cards, identification cards, tickets, boarding passes, etc. For each wallet item, the mobile wallet stores unique account information. For a credit card, for example, the unique account information can be a unique token and cryptograph typically provided by the card network and/or card-issuing bank. In another example, the unique account information for a credit card can be the credit card number and the account holder's name.

The smart card 120 can, for example, be a contact and/or contactless, programmable device capable of connecting with POS devices or ATMs by physical contact or in a contactless manner using near field communications (NFC) for example. The smart card 120 can, for example, include an integrated circuit and memory (e.g., an embedded chip or microcontroller). The smart card 120 conform to one or more international standards (e.g., ISO/IEC 7816 and ISO/IEC 14443) and can be a plastic card similar in size to a credit card or can take a variety of other forms.

In one example, the smart card 120 can be issuer-specific (e.g., a gift card for a particular store) and can have a specific card issuer (e.g., the store) data stored on the card. In another example, the smart card 120 can be a universal card not having card issuer data of a specific card issuer stored thereon but capable of being programmed to for a specific card issuer 150 as described herein. As will be discussed further below, the smart card 120 can be issued with no value and a user's mobile wallet 110 can add monetary value and other content to the card or an account associated with the card (e.g., on a card issuer's computer system or bank system) using a computing device such as smart phone. The smart card 120 can further be given to a recipient (e.g., as a gift) card and submitted as a payment (e.g., at a POS device 130 or ATM 180) or converted to a wallet element in the recipient's mobile wallet (e.g., second mobile wallet 170) for later transactions. The card issuer 150 can be a financial institution such as a bank or other type of organizations issuing credit or debit cards.

The POS device 130 can, for example, be a contact or contactless card reader capable of communicating with the smart card 120 and/or mobile wallets. POS devices can, for example, be located at merchants or financial institutions. To make a payment with a mobile wallet at a POS device, for example, a user can select a wallet item (e.g., credit card item, smart card converted to a wallet element) for the transaction and place the mobile device near the POS card reader. The mobile device can then wirelessly transfer the unique account information (e.g., device account number) for the wallet element to the POS card reader using near field communication (NFC) or magnetic secure transmission (MST), for example. With a smart card, a user can contact or place the smart card near the POS device and the smart card can transfer unique account information to the POS reader. The POS card reader can then, for example, send a merchant identification number, the unique account information and the transaction amount to a processing network (e.g., card network and issuing banks) to authorize payment.

The environment 100 can further include the mobile wallet provider 160. The wallet service provider 160 can, for example, be a computing system capable of interfacing with mobile wallets to set up and manage mobile wallets and enable mobile wallets to include elements from various providers (e.g., card issuers). The wallet service provider can be part of a card issuer system or bank network of can be separate from those systems.

The network 140 can include one or more networks over which the various systems communicate using network interfaces. The network 140 can include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 140 can include a single local area network (LAN) or wide-area network (WAN), or combinations of LAN's or WAN's, such as the Internet.

The card manager applications 114 and 174 can be sub-modules of the respective mobile wallets 112 and 172 (as illustrated) or can be stand-alone modules that interface with the mobile wallets 112 and 172. The card manager applications 114 and 174 can program (read and write data to and from) smart cards and manage smart cards as described herein. For example, card manager 114 can be associated with a giver of a smart card and can be used to program the smart card with an amount of currency and the card manager 174 can be associated with a recipient of the smart card and can be used to read information from the smart card and convert the smart card to a wallet element on the recipient's mobile wallet 172. The term giver can be used herein to refer to the user which programs a smart card and the term recipient can be used herein to refer to the user which receives the smart card and redeems it. It should be appreciated that a giver can also be a recipient.

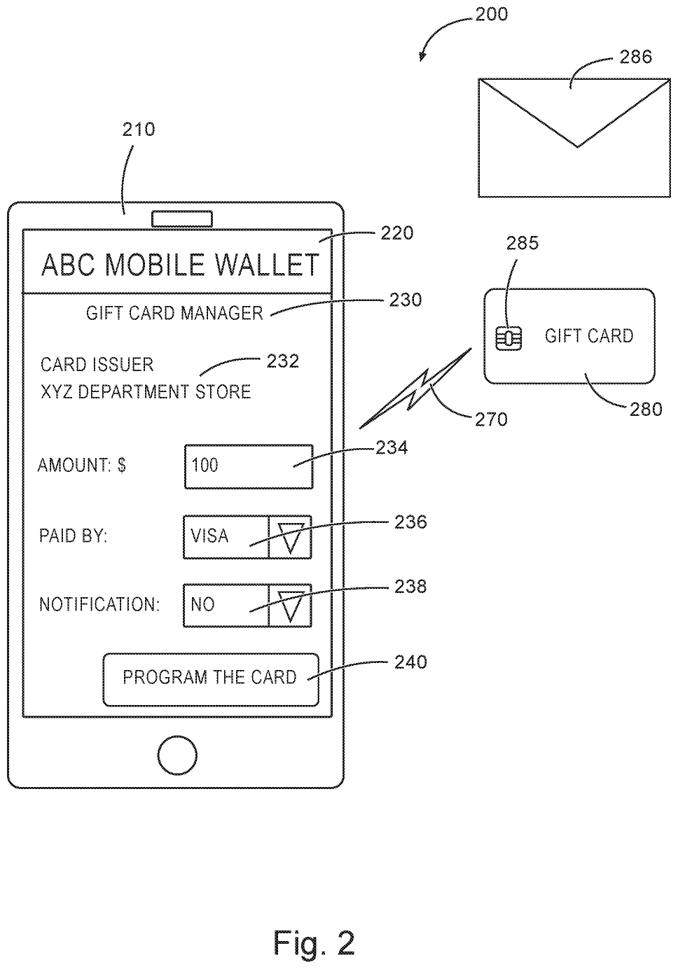

FIG. 2 illustrates an environment 200 for programming an issuer-specific smart card 280, according to an example. The environment 200 includes a mobile wallet 220 accessible by a mobile device 210 such as a smart phone. As noted above, the mobile wallet 220 can, for example, be an application operating on the smart phone or can be an application on a remote system accessible by the smart phone over a network. The smart card 280 can be a card such as a gift card having card issuer data but no value until programmed by a user with a mobile wallet, for example. Once programmed with value, the card can be redeemed at the issuer's store or can be used at other stores specified by the issuer.

The illustrated environment 200 is provided by way of example, and other types of mobile wallet architectures can be used with the systems described herein. For example, the mobile wallet application can operate on other types of computing devices such as desktop computers, laptop computers, and tablets. The use of a smart phone is illustrated in the following examples, but the systems and methods described herein are not so limited.

The example mobile wallet 220 includes card manager application 230 which can program smart cards (e.g., card 280 with a programmable chip 285) wirelessly 270. The card manager 230 allows a giver, for example, to program (read and write) the programmable chip 285 of a blank (e.g., no value) smart card 280. After programming, the giver can provide the smart card to a recipient as a gift in an envelope 286, for example. The mobile wallet 220 and programmable chip 285 can communicate wirelessly over communication path 270. The communication path 270 can, for example, use near filed communication (NFC) (e.g., ISO/IEC 14443) or other technology standards such as Bluetooth or Wi-Fi. In other embodiments, the mobile wallet can use an external chip card reader/writer coupled with the mobile wallet to read and program gift cards.

In the example of FIG. 2, the mobile wallet 220 can establish communication with a blank smart card 280 using near field communication (NFC) 270. The mobile wallet 220 (e.g., through card manager 230) can read the card issuer name and other accessible content of the smart card stored on the card by the issuer and display the card issuer name at 232. Using inputs 234 and 236, the mobile wallet 220 can receive from a giver an amount to load on the card and a payment source 236, and the giver can touch the program gift card button 240 to program the smart card 280 with the amount specified. The payment source can be a credit or debit card or bank account, for example.

In one example, the payment source 236 can be charged at the time the smart card is redeemed. For instance, the card manager 230 can write transaction information associated with the payment source 236 on the smart card in addition to writing the amount on the card. The transaction information can be the giver/cardholder name and card number or a token or device account number for a debit or credit card or can be the giver/account holder's name and the account number and optionally a PIN number for a bank account, for example. When used for a transaction, the smart card can send the transaction information to a processing network for authorization and charging the payment source 236 (via a POS device for example). In another example, the payment source 236 can be charged via a processing network at the time of programming the amount to the smart card. For instance, the card manager 230 can provide a smart card identifier to the processing network and a card issuer can receive the identifier and establish an account for the smart card, associating the account with the smart card identifier.

Input 234 can be used to provide a dollar amount to store on the smart card 280, as illustrated. In addition or in lieu of a dollar amount, the mobile wallet 220 can receive a unique product code or coupon that can be used at the card issuer's store. In the latter case, for example, when the recipient presents the smart card 280 to a POS device to purchase a specified product (e.g., corresponding to the product code), the smart card 280 can send the product code to the POS device and the transaction information for the payment source to process payment for the product at the reduced price.

A giver can also specify whether to receive a notification when the recipient uses the smart card (e.g., when the value becomes $0 or decreases below it's starting value) at input 238. For example, if the notification is yes, a mobile wallet provider or a card issuer can notify the giver's mobile wallet that the smart card 280 was used or the entire value of the card 280 was redeemed. The card manager 220 can include other features. For instance, the card manager can receive user input specifying an expiration date for the smart card, specifying whether the smart card can be converted to cash at a merchant, specifying whether the giver can cancel the card (e.g., if the recipient loses the card), specifying the names of person(s) who can redeem the card, and specifying a location where the card can be used. These use restrictions can be written to the card by the card manager at the time of programming, for example.

A smart card 280 can be converted to a mobile wallet element in a mobile wallet using a card manager. A card manager on a recipient's mobile device can, for example, read the card issuer data and amount (e.g., dollar amount, code, coupon, etc.) stored on the programmable chip of the smart card and store this information in a mobile wallet element in the recipient's mobile wallet. The card manager can also read transaction information from the smart card. The transaction information can be stored in the mobile wallet element for sending to a processing network for payment authorization at the time the wallet element is used or can be sent to a processing network for payment authorization at the time the smart card is converted to the wallet element.

When a recipient's card manager converts a smart card to a mobile wallet element, the card manager can erase the amount and/or transaction information stored on the smart card so that the card cannot be used to make further purchases. In another example, the recipient's card manager can duplicate the smart card, storing an electronic version of the smart card in the mobile wallet without erasing the amount or transaction information on the smart card. In this case, when the recipient uses one of the duplicate cards (e.g., either the smart card or its corresponding wallet element) for a purchase with a processing network, the processing network can receive a unique identifier for the card and update a balance associated with the card to prevent duplicate redemption.

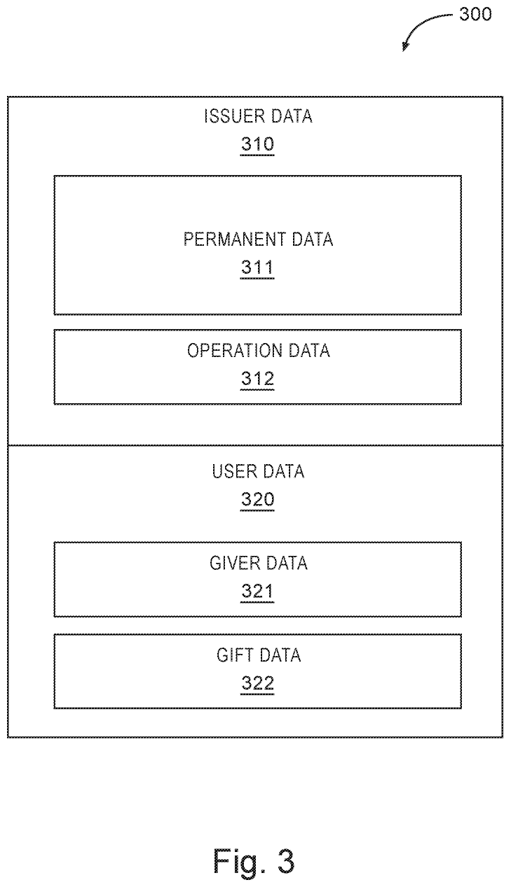

FIG. 3 illustrates a data structure 300 for a smart card according to an example. The data structure 300 can, for example, be stored in a memory on the smart card. The example data structure 300 includes issuer data 310 and user data 320. The issuer data 310 can, for example, include data specified by the issuer when a blank card is issued or programmed such as unique card account information, the issuer name, and other information. The issuer data 310 can be encrypted and some data such as store name and card ID can be readable with mobile wallets or POS devices. The issuer data 310 can, in some examples, include permanent data 311 and operational data 312. The permanent data 311 can, for example, be read only data and the operational data 312 can, for example, be read/write data that can be modified (e.g., by the issuer when issued or by a mobile wallet with permission from an issuer) to assist operation of card use. For instance, if a recipient redeems a portion of the value of the card, the issuer can change the balance of the gift card in the operational data 312.

A mobile wallet can read and write the user data 320 with a card manager application for example. The user data 320 can, for example, include giver data 321, which can specify the name of the giver, a unique identifier of the user's mobile wallet, contact information for the user and the like. The gift data 322 can, for example, include the value of the card and usage limitations set by the user with the mobile wallet. Some or all of the user data 320 can be encrypted for security. User data 320 can be modified by mobile wallets or the issuer. For instance, the value of the gift card can be modified by the giver's mobile wallet and issuer when it is redeemed. When a recipient mobile wallet converts the gift card to a mobile wallet element, the recipient's mobile wallet can set a flag in the gift data 322 to indicate that the gift card has no value.

A card issuer can keep track of the balance of a smart card in the operational data 312 and/or can use a back-end accounting system to track the value, storing in a database the balance of the card and the card's unique identifier. This can, for example, help reduce or prevent fraudulent use.

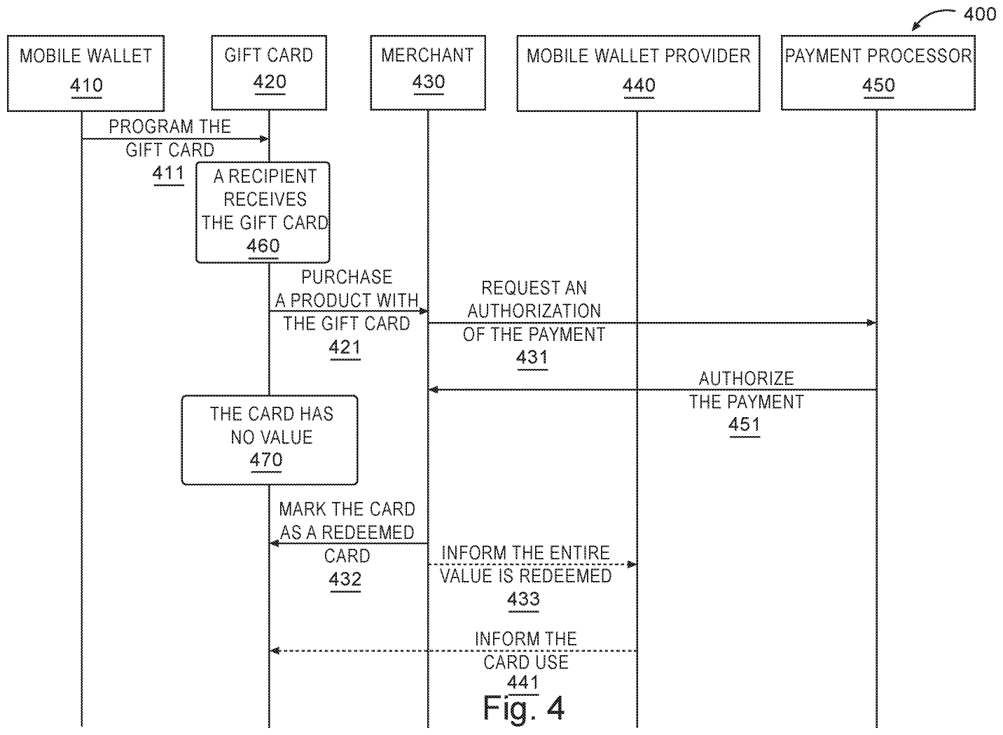

FIG. 4 illustrates a process 400 of using and managing an issuer-specific smart card 420 such as a gift card, according to an example. A mobile wallet 410 can be used by a giver to program a smart card 420 (e.g., according to the processes described with regard to FIGS. 1 and 2) at 411. The giver can give the smart card to a recipient as a gift for example as shown at 460. The recipient can purchase a product or a service with the smart card at a merchant 430 at 421. The merchant 430 can request an authorization of the payment to a payment processor at 431. For instance, if the payment element associated with the gift card is a credit card, a POS device at the merchant 430 can read the transaction information associated with the credit card (e.g., cardholder name and card number, token or device account number (DAN)) from the smart card 420 and use this information to request an authorization from the issuer of the credit card. The payment process 450 can authorize the payment at 451.

If the smart card specified a product instead of dollar value, the merchant can read the product code off the smart card and determine if the product being purchased matches the product specified on the smart card using the product code and if so, request authorization of the price of the product from the payment processor using the transaction information read off the programmable chip of the smart card. After redeeming all or some of the value on the smart card, the POS device at the merchant can revise the value stored on the card (e.g., writing the new value in the issuer data 310 and/or user data 320 shown in FIG. 3) and/or send transaction data to a card issuer to update an accounting database maintained by the issuer.

If the giver requested notification of the smart card's use, the merchant can send a notification message to a mobile wallet provider 440 and the mobile wallet provider 400 can pass a notification message to the mobile wallet 410 of the giver at 433 and 441, respectively. In other embodiment, the merchant 430 can directly send a notification to the mobile wallet 410 using, for example, contact information for the giver or the giver's mobile wallet stored in the user data of the smart card.

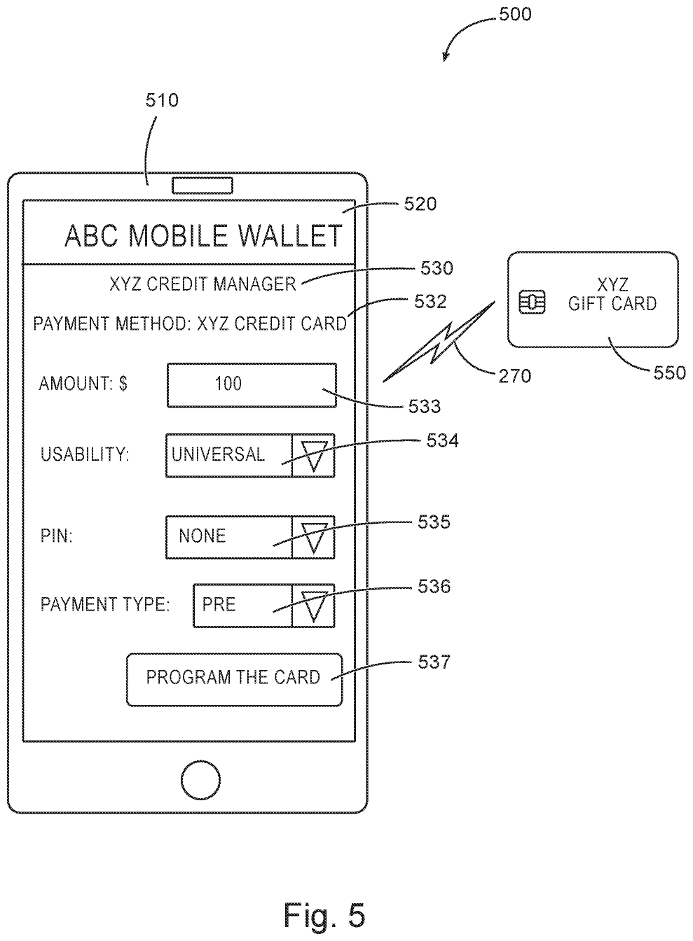

FIG. 5 illustrates an environment 500 for programming a blank universal smart card 550 using a mobile wallet 520, according to another example. The example mobile wallet 520 is accessed through a smart phone 510 and includes a card manager 530. The card manager 530 can, for example, be an application program provided by a credit card issuer or can be part of a the mobile wallet 520. A blank universal card can have issuer data stored on the card but have no value (e.g., no dollar value, coupon or code stored on the card or associated with the card) or can have no issuer data and no value. For example, the universal card 550 can for example be a credit card from a specific bank, storing issuer bank-specific information (e.g., transaction data such as a key used by the bank to process transactions) but having no value (e.g., no value stored on the card).

The mobile wallet 520 owner (e.g., card giver) can contact a card issuer (e.g., a credit card company) (not shown) to download the card manager program 530 or can open an existing card manager 530 in the mobile wallet 520. The card manager 530 can specify a payment element for the universal card 550 at shown at 532. The payment element can be pre-programmed or user selected and includes information associated with a payment source such as a credit or debit card or bank account. This information can include, for example, sufficient information for the universal card 550 to charge the payment source when the card is redeemed.

The card manager can include inputs 533-536 for the user/giver to, for example, specify a dollar amount, usability restrictions, a PIN, and a payment type for the card. The PIN can be a number for the recipient to enter to use the smart card 580. The usability restrictions can, for example, include one or more of an expiration date for the card, a maximum amount that can be spent using the card, and the recipient who can use the card.

After the giver inputs the information, the user can activate (e.g., click, press) the program the card button 537 to program the smart card 550 wirelessly (e.g., using NFC). In other embodiments, the coupling between the smart card 550 and the mobile device 510 can be through a wired connection via an adaptor (not shown). During programming, the inputs from the user can be written to the programmable chip of the smart card 550. While the giver is programming the universal smart card 550 with the credit card manager 530, the mobile wallet 520 can interact with the issuer (not shown) and program content interactively. For example, the mobile wallet 520 can establish communication with the issuer over a network (e.g., the internet) and receive data from the issuer to write on the card or receive data used to write data on the card (e.g., a key to unlock an issuer-specific memory location).

The recipient of a programmed, universal smart card 550 can use the card like a credit or debit card and can, for example, purchase products or services from a merchant or convert the card to cash at an ATM. After programming the card, the card manager can be used by the giver to change the content of the universal smart card through the issuer. For instance, a giver using the card manager can send a message with instructions to the card issuer to extend or remove an expiration date (e.g., specified during initial programming) or cancel the card before the expiration date. A giver using the card manager can send a message to the card issuer with instructions to add more money to an issued universal smart card or change usage restrictions.

In one example, after receiving instructions from a giver, the card issuer can update a database with the changes for the card. In another example, when a recipient uses the universal smart card at a POS device, for example, the card issuer via the POS device can read and write data to the smart card and change the content of the card based on the instruction received by the giver's mobile wallet. In some examples, a mobile wallet provider in addition to or instead of the card issuer can handle the process of issuing, using, and tracking the universal smart card 550.

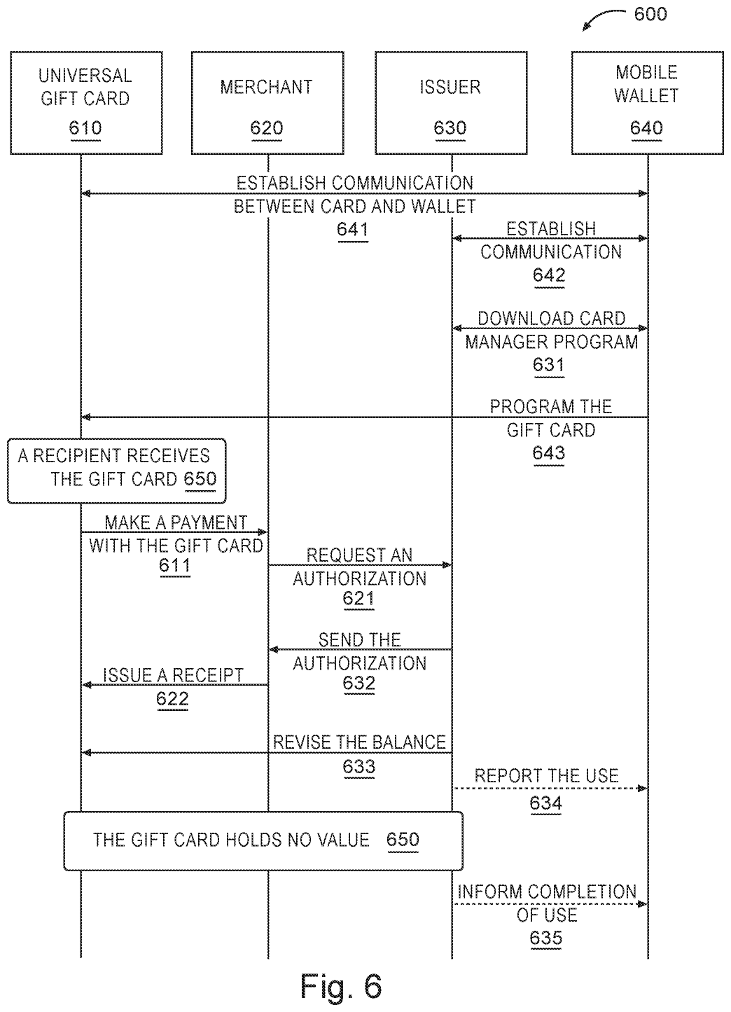

FIG. 6 illustrates a process 600 of programming, using and managing a universal card 610 according to an example. In the example, a mobile wallet 640 establishes communication with a universal smart card at 641. This can be done using NFC or other wireless communication techniques. The mobile wallet 640 can contact the card issuer 630 and establish communication with the card issuer at 642. This can be done using cellular or Wi-Fi networks, for example. At 631, the mobile wallet 640 can download a card manager program if a card manager program is not already on the mobile wallet. The mobile wallet 640 can program the universal card 610 at 643. In other embodiment, the mobile wallet 640 can establish communication with the card issuer 630 first, and then establish communication with and program the universal card 610.

The mobile wallet with the card manager can program the universal card 610 while in communication with the card issuer 630 and universal card 610. For example, while programming the universal card 610, the mobile wallet 640 can also communicate with the card issuer 630 so that the card issuer 430 is aware of the new card 610 and its content.

The mobile wallet 640 owner (e.g., giver) can give the universal card 610 to a recipient (e.g., as a gift) at 650. The recipient can make a payment with the universal card 610 at a merchant 620 as illustrated at 611. The merchant 620 can, for example, send an authorization request to the card issuer 630 via a payment processing network (not shown) at 621. The card issuer 630 can send authorization to the merchant at 632. The merchant can also issue a receipt to the universal card 610 as shown at 622. While the card 610 is coupled with the POS device at the merchant 620, the card issuer can revise the balance stored on the universal card at 633. The card issuer can also or alternatively update an external database storing a card account based on the transaction.

Depending on the specifications provided by the giver (e.g., during initial programming or thereafter), the card issuer 630 can report each transaction to the mobile wallet 640 as shown at 634 and/or inform the mobile wallet 640 when of the completion of card use as shown at 635 if the recipient uses up the entire value of the universal smart card. The recipient of the universal smart card 610 can also convert the card 610 to a mobile wallet element using his or her own mobile wallet. When a universal smart card is converted to a mobile wallet element, a card manager on the recipient's device can, for example, erase the value on the smart card and/or send a message to the card issuer to erase the value. the gift card can be void. In other embodiments, the mobile wallet element can be a duplicate of the universal card 610. In this case, for example, both the card and wallet element can be used for transactions and the card issuer can keep track of the use and update a balance associated with the card.

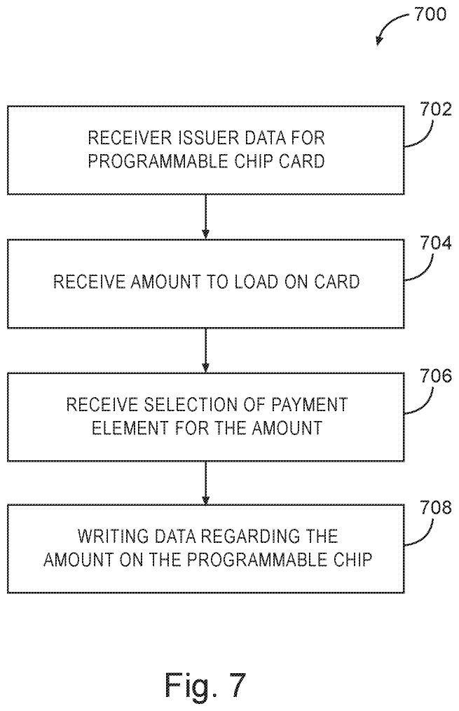

FIG. 7 illustrates a method 700 for programming a smart card having a programmable chip with no value using a mobile wallet, according to an example. The mobile wallet can, for example, operate on a mobile device such as phone or tablet or can operate on a server which can be accessed over a network by a mobile device. The smart card can, for example, be a merchant gift card that includes a programmable chip storing issuer data for the merchant. In another example, the smart card can be a universal gift card that includes a programmable chip that includes a memory location for issuer data but does not have issuer data. The smart card can initially hold no value. The mobile wallet via the mobile device can, for example, establish connection with the programmable chip of the smart card using NFC in order to read and write information to the chip. While the method 700 is described with reference to a mobile wallet, it should be appreciate that the method 700 can be carried out by another application operating on the mobile device.

At 702, the mobile wallet receives issuer data identifying an issuer for the smart card. This can include, for example, the mobile wallet reading issuer data from smart card or the mobile wallet receiving issuer information from a user through the user interface of the mobile device. In one example, the mobile wallet reads the programmable chip and determines if the programmable chip includes issuer data identifying an issuer of the card. If it does not have issuer data (e.g., such as universal card), the mobile wallet can prompt the user to enter issuer information.

At 704, the mobile wallet can receive an amount to load on the card. For example, a user can enter an amount of dollars (or other currency denomination) for the gift card using the mobile device in communication with the smart card. In other example, the amount can be a promotional code or coupon. At 706, the mobile wallet can receive a selection of a payment element as a payment source for the amount. In one example, the mobile wallet can receive a user selection of a wallet element from the mobile wallet as the payment source. The user can, for example, select a credit card or debit card wallet element as the payment source for the amount to be loaded on the smart card. In other example, the mobile wallet can automatically select a wallet element from among the wallet elements in the mobile wallet based on pre-set user preferences or usage history, for example.

At 708, after receiving the payment element selection, the mobile wallet can write data regarding the amount on the programmable chip of the smart card. For example, the mobile wallet can write a dollar (or other currency value) to a user data field on the memory of the programmable chip of the smart card. In another example, the mobile wallet can write to the memory, as the amount, a code or coupon that can be redeemed at a merchant (e.g., for a particular discount of a product or service). In another example, the mobile wallet can send an external account associated with the card a currency value to associate with the smart card.

In one example, the mobile wallet writes transaction information regarding the selected payment element on the gift card along with the amount. The information can, for example, include the name of the cardholder and the card number for a selected credit or debit card. In other examples, the information can include a token or device account number (DAN) associated with the selected payment element. When the gift card is redeemed, the POS device can receive the transaction information (e.g., cardholder name and card number, token, DAN) and submit the transaction information to a processing network for payment authorization. In this manner, the cardholder (e.g., giver's) card is charged at the time of redemption.

In another example, after receiving the payment element selection, the mobile wallet can submit a payment request for a portion or all of the amount to processing network (e.g., associated with the issuer) using the selected payment element (e.g., a credit or debit card element). The payment request can for example include transaction data (e.g., cardholder name and number, token, device account number, etc.) associated with the selected payment element.

After the mobile device receives authorization, the mobile device can write the data regarding the amount on the programmable chip of the smart card. In this manner, the cardholder account associated with the payment element (e.g., a credit card account with a card issuer) is charged at the time of programming the gift card. The mobile wallet/card manager can send an identification number of the smart card (e.g., read off the smart card chip by the mobile wallet) to the card issuer. Using the identification number, the card issuer can maintain an account for the universal card, associating the account with the amount and the identification number of the smart card to track transactions with the universal card.

In the case of a smart card without issuer data, the method 700 can further include the mobile wallet writing issuer data on the programmable chip after receiving the issuer information from the user. The mobile wallet can, for example, receive the issuer information from the user and establish connection with the issuer over a wireless network for example. The mobile wallet can send a message to the issuer requesting to create a universal gift card in the issuer's name and can receive a key from the issuer to enable writing issuer data to a restricted memory location identifying the issuer data for the card. In this way, for example, a user can obtain a universal (e.g., issuer independent card) and create an issuer-specific card (e.g., a Wells Fargo Visa card).

The method 700 can further include the mobile wallet receiving one or more use restrictions regarding the amount and writing the use restrictions on the programmable chip. The use restrictions can, for example, be provided by the user using the mobile device during the initial programming of the gift card. The use restrictions can be written to the programmable chip and stored in the memory. The use restrictions can also be sent to the issuer and stored on an issuer database in addition to or in lieu of being stored on the chip memory. Use restrictions can, for example, be set that specify one or more category of goods or services that can be purchased with the card and/or one or more merchants at which the amount on the card can be redeemed. A transaction pin can also be established and required to be input to authorize use of the card. The mobile wallet can, for example, receive a transaction pin for the smart chip from the user or from the issuer and write the transaction pin on the programmable chip.

The method 700 can further include the mobile wallet receiving a notification of use of some or all of the amount of the smart card. For example, the smart card can be programmed with a notification flag by the mobile wallet during initial set up and a POS card reader can the notification flag and send a message to the issuer to inform the mobile wallet of the use. The message can, for example, include transaction information such as the place of use and the amount of the transaction. In other examples, the POS card reader can send a message to a wallet service provider that can then inform the mobile wallet of the use.

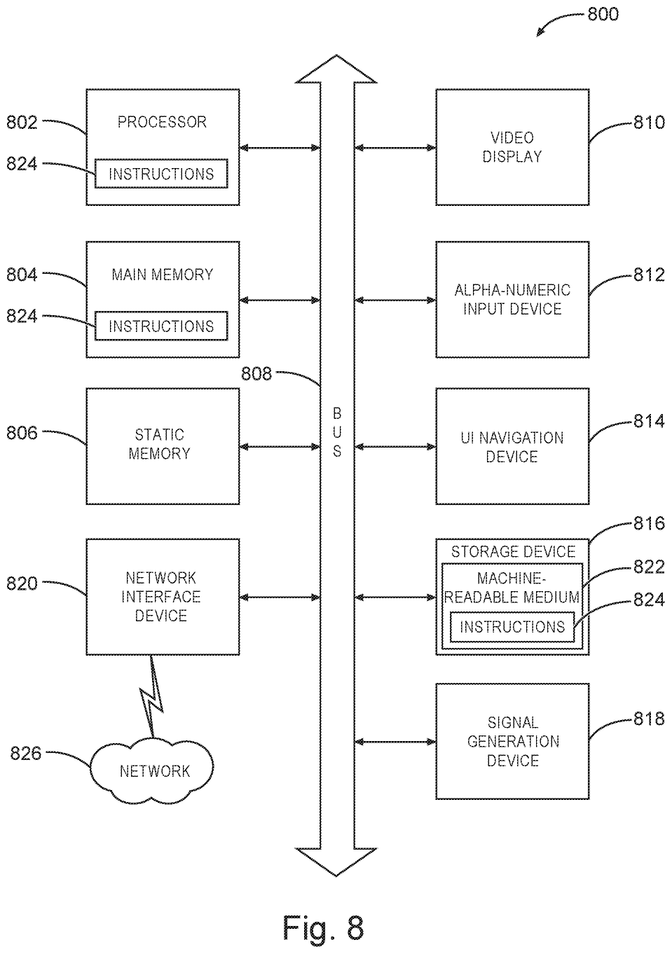

FIG. 8 is a block diagram illustrating a machine in the example form of a computer system 800, within which a set or sequence of instructions can be executed to cause the machine to perform any one of the methodologies discussed herein, according to an example embodiment. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 can further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 can additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” can include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for programming a smart card having a programmable chip using a mobile wallet associated with a mobile device, the method comprising:
establishing a near field communication connection between the mobile device of a giver and the programmable chip of the smart card, wherein the mobile wallet is a mobile wallet of the giver operating on the mobile device, and wherein the smart card initially has no associated value;
receiving, using a processor of the mobile device, issuer data from a data structure stored in a read only portion of memory of the smart card through the near field communication connection, the issuer data identifying an issuer for the smart card, wherein the issuer for the smart card is a merchant that issued the smart card to the giver;
enabling use of the smart card to perform transactions with the merchant based on the issuer data;
receiving, using the processor of the mobile device, a monetary amount to associate with the smart card from the giver that was issued the smart card from the merchant through an interface of the mobile device;
selecting, using the processor of the mobile device, a payment element as a payment source for the monetary amount by selecting a wallet element of a plurality of wallet elements of the mobile wallet of the giver based on usage history of the plurality of wallet elements by the giver;
writing data, using the processor of the mobile device and through the near field communication connection, regarding an account associated with the payment source for the monetary amount on the programmable chip of the smart card at a read/write portion of the memory of the smart card in response to selecting the payment element, the writing enabling use of the monetary amount by a recipient separate from the giver to perform a transaction with the merchant;
receiving, at the mobile device, a notification of use of the smart card directly from the merchant that the monetary amount has been redeemed; and
subsequent to writing the data regarding the account associated with the payment source, transmitting a message to the merchant to increase the monetary amount associated with the smart card to enable the merchant to update the monetary amount associated with the smart card upon the recipient performing the transaction with the merchant.

2.-3. (canceled)

4. The method of claim 1, further including determining, prior to receiving the issuer data, that the programmable chip does not have any issuer data for the issuer and prompting a user to enter issuer information based on the determination.

5. The method of claim 4, further including writing issuer data on the programmable chip on the read/write portion of the memory of the smart card.

6. The method of claim 5, wherein writing issuer data on the programmable chip includes receiving a key from the merchant to enable writing issuer data to restricted memory locations.

7. The method of claim 1, wherein writing data indicating the amount includes writing a currency value on the programmable chip.

8. The method of claim 1, wherein writing data indicating the amount includes writing a product code or coupon redeemable from the merchant on the programmable chip.

9. The method of claim 1, further including receiving one or more use restrictions from the merchant regarding the amount and writing the use restrictions on the programmable chip.

10. The method of claim 1, further including receiving a transaction pin for the smart chip and writing the transaction pin on the programmable chip.

11-13. (canceled)

14. The method of claim 1, wherein writing data includes writing information regarding the payment element on the programmable chip of the smart card.

15. The method of claim 1, further comprising:
submitting, with the mobile device, a payment request to a processing network associated with the payment element for authorization of the amount; and
receiving, with the mobile device, the authorization;
wherein writing the data indicating the amount on the programmable chip of the smart card includes writing the data after receiving the authorization.

16. A non-transitory computer-readable storage medium, the computer-readable storage medium including instructions that when executed by a computer, cause the computer to perform operations of:
establishing a near field communication connection with a programmable chip of a smart card, wherein the smart card initially has no associated value;
receiving issuer data identifying an issuer from a data structure stored in a read only portion of memory of the smart card through the near field communication connection, the issuer data identifying an issuer for the smart card, wherein the issuer is a merchant that issued the smart card to a giver;
enabling use of the smart card to perform transactions with the merchant based on the issuer data;
receiving a monetary amount to associate with the smart card from the giver that was issued the smart card from the merchant through an interface;
selecting a payment source for the monetary amount, the payment source comprising a wallet element of a plurality of wallet elements of a mobile wallet associated with a mobile device of the giver selected based on usage history of the plurality of wallet elements by the giver;
writing data regarding an account associated with the payment source for the monetary amount on the programmable chip of the smart card at a read/write portion of the memory of the smart card, the writing enabling use of the monetary amount by a recipient separate from the giver to perform a transaction with the merchant;
receiving, at the mobile device, a notification of use of the smart card directly from the merchant that the monetary amount has been redeemed; and
subsequent to writing the data regarding the account associated with the payment source, transmitting a message to the merchant to increase the monetary amount associated with the smart card to enable the merchant to update the monetary amount associated with the smart card upon the recipient performing the transaction with the merchant.

17. The computer-readable storage medium of claim 16, wherein the operations further include:
receiving one or more use restrictions regarding the amount and writing the use restrictions on the programmable chip.

18. The computer-readable storage medium of claim 16, wherein the operations further include: prior to receiving the issuer data, determining the programmable chip does not have any issuer data for the issuer; establishing communications with an issuer identified by a user; receiving a key from the issuer to enable writing issuer data to a restricted memory location and writing issuer data on the restricted memory location of the programmable chip.

19. A system comprising:
a processor; and
a memory storing instructions that, when executed by the processor, configure the processor to:
establish a near field communication connection with a programmable chip of a smart card, wherein the smart card initially has no associated value;
receive issuer data identifying an issuer from a data structure stored in a read only portion of a memory of the smart card through the near field communication connection, wherein the issuer is a merchant that issued the smart card to a giver;
enable use of the smart card to perform transactions with the merchant based on the issuer data;
receive a monetary amount to load on the smart card from the giver that was issued the smart card from the merchant;
select a wallet element from a mobile wallet associated with mobile device of the giver as a payment source for the monetary amount, the wallet element selected based on usage history of a plurality of wallet elements of the mobile wallet by the giver;
write data regarding an account associated with the payment source for the monetary amount on the programmable chip of the smart card at a read/write portion of the memory of the smart card, the writing enabling use of the monetary amount by a recipient separate from the giver to perform a transaction with the merchant;
receive, at the mobile device, a notification of use of the smart card directly from the merchant that the monetary amount has been redeemed; and
subsequent to writing the data regarding the account associated with the payment source, transmit a message to the merchant to increase the monetary amount associated with the smart card to enable the merchant to update the monetary amount associated with the smart card upon the recipient performing the transaction with the merchant.

20. (canceled)

21. The method of claim 1, further comprising writing data including a unique identifier of the mobile wallet, using the processor, on the programmable chip at a read/write portion of memory of the smart card.
